(19) United States
(12) Patent Application Publication
(10) Pub. No.: US 2006/0229073 A1
(43) Pub. Date: Oct. 12, 2006

(54) Transmitting handoff messages using higher power

(76) Inventors: Suman Das, Scotch Plains, NJ (US); Ali Masoomzadeh-Fard, Marlboro, NJ (US); Martin H. Meyers, Montclair, NJ (US); Harish Viswanathan, Morristown, NJ (US)

Correspondence Address: CARLSON, GASKEY & OLDS, P.C., 400 W MAPLE RD, SUITE 350, BIRMINGHAM, MI, 48009, US

(21) Appl. No.: 11/095,018

(22) Filed: Mar. 31, 2005

(51) Int. Cl. H04Q 7/20; H04B 7/216; H04Q 7/00

(52) U.S. Cl. 455/436; 370/335; 370/331; 455/437; 455/438

(57) ABSTRACT

A wireless communication network (20) includes a power management module (50) for controlling the power of transmission between a base station (38) and a mobile station (40). Bearer traffic (e.g., voice or data signals) are transmitted using a first transmission power limit. Handoff messages are transmitted using a second, higher transmission power limit. In one example, the power management module (50) selects an increment to the first transmission power limit for purposes of transmitting handoff signals.

### FIELD OF THE INVENTION

This invention generally relates to telecommunications. More particularly, this invention relates to wireless communication systems.

### DESCRIPTION OF THE RELATED ART

Wireless communication systems are well known and in widespread use. Typical systems include a plurality of base stations arranged to serve specific geographic areas or cells. An individual can use a mobile station to communicate through the wireless communication system as their mobile station communicates with a base station serving the cell in which they are currently located.

As a mobile station moves from one cell to another, communications for that mobile station must be handled by different base stations at different times. As a mobile station moves from one cell to another cell, the communications for that mobile station are transferred from the base station serving the one cell to the base station serving the other cell. The process of transferring communications for a mobile station between base stations is known as “handoff.”

Typically, a mobile station monitors a pilot signal or other signal strength indicator to determine what base station is providing a useful signal for communications. As the mobile station approaches the edge of the cell in which it is currently located, the signal from the base station serving that cell typically weakens while a signal from a base station in an adjacent cell typically becomes stronger. In many instances, a mobile station recognizes these conditions and requests a handoff to the next base station. The requested base station is often called a target base station. According to existing communication protocols, mobile stations may request a handoff to one or more base stations based upon the relative measured strengths of the pilot signals of the base stations.

Wireless communication networks can also trigger handoff procedures based upon periodic measurement reports from mobile stations or for other reasons such as bearer traffic management in one or more cells.

One type of wireless communication system is known as a Code Division Multiple Access (CDMA) system. Handoffs used in CDMA systems are known as “soft” handoffs. A mobile station and a wireless network that use soft handoff procedures establish communication with a target base station before terminating communication with an existing or currently serving base station. During a soft handoff procedure, a mobile station is in simultaneous communication with more than one base station. Soft handoff procedures typically are employed to ensure that there is no interruption of communication between the mobile station and the wireless network through at least one base station. Eventually, a soft handoff process is completed and the mobile station communicates only through the target base station, which becomes the existing or serving base station after the handoff is complete.

In soft handoff procedures, the mobile station is in simultaneous communication, using a communication link comprising one or more communication channels, with each base station that is a member of an active set for that mobile station. Eventually, the handoff process transfers communication to only one of the base stations in the active set.

A drawback associated with the current approach in CDMA systems is that there is a cost associated with a dedicated channel being used in the soft handoff process. Additionally, soft handoff procedures require using more Walsh codes (e.g., one code for each member of the active set) and strict synchronization between cells is required.

It has not previously been possible to complete a handoff for dedicated channels in CDMA systems with sufficient reliability without using soft handoff procedures. In the absence of soft handoff for a dedicated channel, the switch from one cell to another must be very quick to avoid dropping a call. The signaling associated with the handover must be reliable to avoid retransmissions that introduce additional delay. Moreover, when a current or existing cell signal quality is not good, it is possible for handoff signaling to fail to get through quickly enough before the current link quality becomes unreliable. Under some circumstances, this may result in a dropped call because switching to a better-situated base station depends upon fast and reliable handoff signaling between the mobile station and the wireless communication network. As mobile stations move at higher speeds, this problem becomes more prevalent.

Regardless of the handoff strategy used, it is necessary to ensure that handoff messages are communicated in both directions (e.g., in the uplink and the downlink directions) as quickly and effectively as possible to avoid call drops and degraded performance. Each handoff requires at least one message in each direction. When it is desirable to use hard handoff procedures, this is especially true because the existing link between the serving base station and a mobile station may already be weaker than the new link to which the mobile station is going to be transferred. Especially at high mobile speeds, the quality of the existing link may decrease rapidly.

There is a need for an improved technique for completing handoffs in CDMA systems. It would be beneficial to be able to avoid the use of resources required for soft handoff procedures. At the same time, any hard handoff procedure must be reliable enough to avoid dropped calls

### SUMMARY OF THE INVENTION

This invention addresses the need for an improved technique for completing handoffs in CDMA systems. More particularly, this invention provides enhanced communications for facilitating a handoff procedure and allows for increased performance and reliability even if hard handoff procedures are implemented.

A disclosed example method of communicating includes transmitting bearer traffic (e.g., voice or data signals) using a first transmission power limit. At least one handoff signal is transmitted using a second transmission power limit that is relatively higher than the first transmission power limit.

In one example, the bearer traffic is buffered while transmitting the at least one handoff signal.

In one example, the first transmission power limit corresponds to a normal, maximum transmission power selected to avoid interference. The second transmission power limit corresponds to the first transmission power limit plus a selected transmission power increment.

By transmitting the handoff message at a second, higher transmission power limit, one example ensures that the handoff signal will be reliably received to facilitate a handoff process.

Another example method includes receiving bearer traffic (e.g., voice or data signals) at a first transmission power. At least one handoff signal is received at a second transmission power that is relatively higher than the first transmission power.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically shows selected portions of a wireless communication system that utilizes a handoff signal transmission strategy designed according to an embodiment of this invention.

FIG. 2 is a flowchart diagram summarizing an example handoff signal transmission strategy.

### DETAILED DESCRIPTION

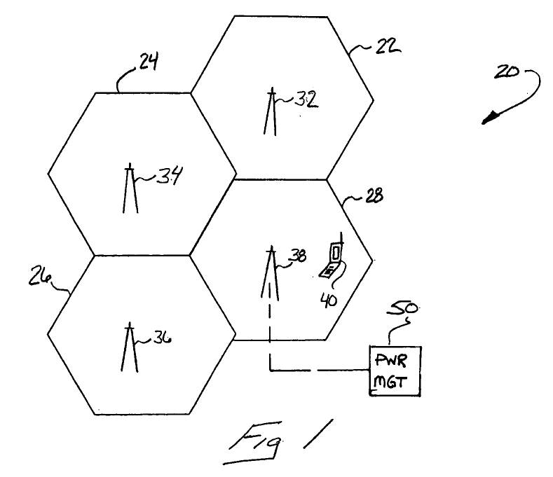

FIG. 1 schematically shows selected portions of a wireless communication network 20. A plurality of cells 22, 24, 26 and 28 are served by base stations 32, 34, 36 and 38, respectively. The base stations 32-38 communicate with a radio network controller and other portions of a wireless communication network in a known manner.

A mobile station 40 is schematically shown within the geographic region or area of coverage of the cell 28. Communications between the mobile station 40 and another device using the wireless communication network occurs over an existing link between the base station 38 and the mobile station 40. The base station 38 in this instance is considered a serving base station or an existing base station for purposes of this description.

Eventually the mobile station 40 moves into another region corresponding to another one of the cells. As such movement occurs, a handoff between the existing base station 38 and a new or target base station (e.g., the base station serving the cell that the mobile station 40 is entering) must occur.

Whether a handoff is triggered by the mobile station 40 or by another portion of the network 20, it is necessary for at least two messages to be communicated between the mobile station 40 and an appropriate portion of the network. Communicating handoff messages as quickly as possible avoids call drops and provides more reliable performance.

The messages between the mobile station 40 and the wireless communication network (e.g., a radio network controller) include at least one message in the uplink direction and one message in the downlink direction. When a handoff process is triggered by the network, there is at least one message in the downlink direction and one message in the uplink direction. If the mobile station 40 triggers a handoff, there is an additional message in the uplink direction indicating the desire for the handoff.

The radio network controller sends an active set update message to the mobile in the downlink direction regardless of how the handoff is initiated. The illustrated example includes using an increased transmit power when transmitting handoff messages in at least the downlink direction. A power management module 50 is schematically shown associated with the base station 38. The power management module 50 controls the transmission power used for communications between the base station 38 and the mobile station 40. Normal bearer traffic (e.g., voice or data) communications occur using a transmission power below a selected limit that allows for effective signal communication and avoiding interference. There are known techniques for selecting such transmission power limits. The bearer traffic signals in this example are transmitted using a first transmission power limit. The power management module 50 controls the transmission power.

FIG. 1 schematically shows an example power management module 50. In some systems, each base station will have a dedicated power management module 50. In other examples, the functions of the power management module 50 are performed by an appropriate portion of the wireless network. Given this description, those skilled in the art will realize what hardware, software, firmware or a combination of them will best meet the needs of their particular situation for implementing a power control module like the disclosed example.

During a handoff procedure, handoff signaling is transmitted using a second transmission power limit, which is relatively higher than the first transmission power limit, to increase the likelihood that the handoff signaling is received by the mobile station 40 in a sufficiently fast and reliable manner. Increasing the speed and reliability of handoff signal transmissions by increasing the transmission power allows for more freedom in selecting handoff techniques and reduces the strict synchronization and latency requirements that are associated with many known handoff techniques.

Increasing the transmission power for the handoff messages or signals does not introduce appreciable interference in most situations. Further, the frequency with which handoff signals are transmitted is much lower than that with which bearer traffic is transmitted and, therefore, increasing the transmission power for handoff signals does not tap network resources in an undesirable manner.

In one example, bearer traffic is buffered during a handoff procedure. Accordingly, in the downlink (e.g., from the base station 38 to the mobile station 40) only low rate handoff signaling occurs during a handoff procedure. Using a higher transmission power for handoff signals is desirable. The spreading factor in the downlink is constant, which requires using discontinuous transmission if there is no user data (e.g., bearer traffic) to transmit during a handoff procedure. It follows that the instantaneous maximum power required to transmit handoff signaling remains the same. Therefore, increasing the maximum power of transmission on a dedicated channel, for example, during handoff allows for the handoff signaling to reach the mobile station 40 more quickly. This allows for simplex operation such as the mobile station maintaining only one base station within an active set for the mobile station at all times. In other words, increasing the transmission power used for handoff signaling facilitates a hard handover procedure that has performance and reliability characteristics corresponding to those expected from soft handoff procedures.

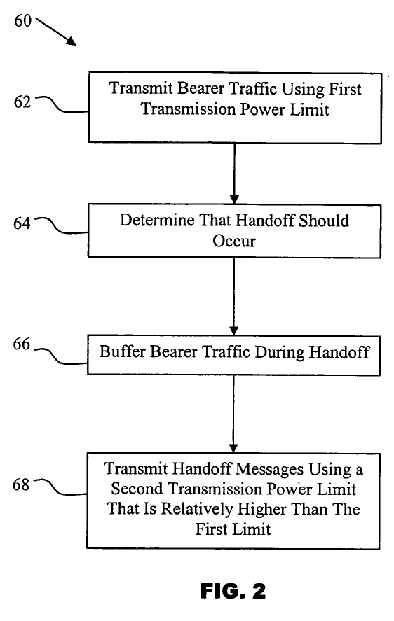

FIG. 2 includes a flow chart 60 summarizing one exemplary approach. The first transmission power limit is used for bearer traffic communications at 62. The radio network controller or another appropriate portion of the communication system determines that a handoff is desirable or necessary at 64. In this example, bearer traffic is buffered during a handoff as shown at 66. The actual handoff messages used for the handoff procedure are transmitted at 68 using the second, relatively higher transmission power limit.

One example CDMA system transmits handoff messages over a dedicated physical channel even when bearer traffic data signals are transmitted over a high rate shared channel. The disclosed example allows for using a higher transmission power for the handoff messages sent over the dedicated channel.

By allowing for using hard handoff procedures, the disclosed example technique of transmitting handoff messages using a higher transmission power than that used for bearer traffic reduces the requirement to use soft handoff, which reduces the requirements for tight synchronization between cells. Moreover, using a hard handoff procedure allows for reducing the number of Walsh codes per user since each mobile station has only one base station within its active set at all times. Accordingly, simplex operation can be used for dedicated channels and high data rate shared channels, which potentially decreases interference and increases system capacity.

In one example, handoff messages in the uplink direction (e.g., from the mobile station 40 to the base station 38) are not transmitted using an increased power beyond that used for bearer traffic in the uplink direction. The spreading factor in the uplink is adjusted dynamically and transmission is continuous. In such an example it is not necessary to increase the maximum transmission power in the uplink direction because the user bearer traffic transmission is buffered during the handoff procedure. Therefore, higher transmission power is available for handoff messages to get through without any need for higher maximum power. There is only a need to send the handoff signals during the handoff process. In other words, the physical channel data rate is relatively low during the handoff procedure and, therefore, higher transmission power can be used for handoff messages in the uplink.

Another reason why it is not necessary in some examples to increase the transmission power in the uplink direction is that dynamic rate matching in the uplink has a lower maximum power requirement, especially for lower rate physical channels. There is no discontinuous transmission in the uplink and all the symbols in the radio frame are always used. By adjusting the spreading factor and repetition, the number of symbols in the uplink is always adjusted in a way that all symbols are used. The instantaneous transmission power is not high because the user data or other bearer traffic is buffered and only low rate handoff signaling transmission occurs in the uplink direction during a handoff procedure.

Of course, it is possible in some situations to increase the transmission power in the uplink for transmitting handoff signaling. Some example implementations of this invention include using a higher transmission power limit in the uplink direction and the downlink direction.

One advantage to the disclosed arrangement is that although maximum instantaneous power is increased during the handoff procedure for transmitting the handoff messages, the average transmit power remains the same and can be maintained within selected limits as are typically chosen to avoid interference (e.g., at bearer traffic transmit power levels).

In one example, the power management module 50 utilizes known techniques for controlling a first transmission power for normal bearer traffic communications between the mobile station 40 and the base station 38, for example. One example includes selecting an increment to the first transmission power limit for establishing the second, higher transmission power limit for handoff signaling. In one example, selecting the increment depends on the current working power used for bearer traffic transmission. For example, a 35 dBm limit may be the maximum power limit available for a downlink in a particular wireless communication network. Under circumstances where the current working power or first transmission power is 20 dBm, an increment of 5 dB for purposes of transmitting handoff signals is used. In this example, the 25 dBm handoff message transmission power limit is lower than the system maximum of 35 dBm.

In another example, the working power is 33 dBm so that the increment for handoff signaling cannot be any more than 2 dB without exceeding the 35 dBm overall limit imposed on the system.

In some examples, the increment to the first transmission power limit to allow for an increased second transmission power for handoff messages is selected to be within a range that has an upper limit that does not introduce unnecessary system interference and a lower limit that is high enough to ensure reliable signaling transmission and reception (e.g., high enough to avoid dropped calls). Given this description, those skilled in the art will be able to select appropriate transmission powers for bearer traffic and handoff messages, respectively, to meet the needs of their particular situation.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of communicating, comprising:
transmitting bearer traffic using a first transmission power limit; and
transmitting at least one handoff signal using a second transmission power limit that is relatively higher than the first transmission power limit.

2. The method of claim 1, comprising:
buffering bearer traffic while transmitting the at least one handoff signal.

3. The method of claim 1, wherein the first transmission power limit corresponds to a maximum transmission power selected for avoiding interference.

4. The method of claim 3, wherein the second transmission power limit corresponds to the first transmission power limit plus a selected transmission power increment.

5. The method of claim 4, comprising selecting the transmission power increment based on a current value of the first transmission power limit.

6. The method of claim 4, comprising selecting the transmission power increment based on a current bearer traffic transmission power level.

7. The method of claim 4, comprising selecting the transmission power increment based on a maximum system transmission power.

8. The method of claim 7, wherein the second transmission power limit is less than the maximum system transmission power.

9. The method of claim 1, comprising transmitting the at least one handoff message on a downlink.

10. The method of claim 1, comprising transmitting the at least one handoff message on an uplink.

11. The method of claim 1, comprising using code division multiple access (CDMA).

12. The method of claim 11, comprising transmitting the bearer traffic over a shared data channel and transmitting the at least one handoff message over an associated dedicated channel.

13. The method of claim 12, comprising adjusting a maximum transmission power over the dedicated channel from a first level corresponding to the first transmission power limit to a second level for transmitting the at least one handoff message.

14. The method of claim 13, comprising adjusting the maximum transmission power over the dedicated channel responsive to initiation of a handoff procedure.

15. The method of claim 14, comprising initiating the handoff procedure using a portion of a wireless communication network.

16. The method of claim 14, comprising initiating the handoff procedure using a mobile station.

17. The method of claim 1, comprising using the at least one handoff message for a hard handoff.

18. A method of communicating, comprising:
receiving bearer traffic at a first transmission power; and
receiving at least one handoff signal at a second transmission power that is relatively higher than the first transmission power.

19. The method of claim 18, comprising
receiving the bearer traffic on a shared channel; and
receiving the at least one handoff signal on a dedicated channel.

20. The method of claim 18, comprising providing a receipt signal acknowledging the received handoff signal.
